(19) United States
(12) Patent Application Publication
(10) Pub. No.: US 2009/0150219 A1
(43) Pub. Date: Jun. 11, 2009

(54) Systems and methods for delivering media content

(75) Inventors: Kevin P. Headings, Pacific Palisades, CA (US); Justin W. Heymanson, Los Angeles, CA (US); Farhad G. Garakani, Culver City, CA (US); Samuel J. Beckman, Thousand Oaks, CA (US); David Wong, Los Angeles, CA (US); Kenneth G. Lau, Los Angeles, CA (US); Richard T. O'Halloran, Pacific Palisades, CA (US)

Correspondence Address: MARTIN & FERRARO, LLP, 1557 LAKE O'PINES STREET, NE, HARTVILLE, OH, 44632, US

(73) Assignee: Intertainer, Inc.

(21) Appl. No.: 12/322,742

(22) Filed: Feb. 7, 2009

Related U.S. Application Data
(63) Continuation of application No. 09/922,651, filed on Aug. 7, 2001, now abandoned.
(60) Provisional application No. 60/255,750, filed on Dec. 14, 2000.
(60) Provisional application No. 60/255,725, filed on Dec. 14, 2000.
(60) Provisional application No. 60/309,734, filed on Jul. 31, 2001.

(51) Int. Cl. G06Q 30/00; G06Q 10/00; G06F 17/30; G06F 17/40; G06Q 50/00

(52) U.S. Cl. 705/10; 705/26; 707/104.1; 707/E17.018; 707/E17.028; 707/E17.044

(57) ABSTRACT

The present invention is directed to a system and method for offering media content to consumers for a selected interval of time. In one or more embodiments, the present invention uses a content management system for preparing the media content for distribution, a subscriber management system for managing consumer accounts, a content distribution system for distributing the media content to the consumers, and a licensing server for issuing licenses restricting the use of media content.

### RELATED APPLICATIONS

This application is a continuation of U.S. application Ser. No. 09/922,651, filed Aug. 7, 2001; which claims the benefit of U.S. Provisional Application Ser. Nos. 60/255,750 and 60/255,725, filed Dec. 14, 2000, and U.S. Provisional Application No. 60/309,734, filed Jul. 31, 2001; all of which are incorporated by reference herein.

### BACKGROUND OF THE INVENTION

The digitization of media content (e.g., movies, music videos, educational content, television shows, games, live events, advertising, literary works, audio programs, and other media assets) is becoming more common with the advent of technology that allows content suppliers to derive revenues from these assets in a digital marketplace. Content suppliers may include entities that own the content, have rights to the content, or are otherwise suppliers of the media assets. For purposes herein, media assets form a subset of media content. There is a cost for entry into the digital space that requires infrastructure and processes to effectively manage and distribute various forms of media assets, particularly over high bandwidth channels of communication (e.g., digital cable, Internet protocol, and satellite). Content suppliers are not traditionally equipped to handle these requirements and would benefit from a system that minimizes the barrier to entry into the digital marketplace.

Users of content also have barriers in the digital marketplace. For purposes hereof, a “content user” is any person or entity that sells or otherwise exploits media assets. A content user may be, for example, the content supplier, a digital services platform operator, an online site builder, an educational institution, or a retailer. One issue facing content users is the distribution of media assets to consumers over one or more delivery platforms (e.g., digital subscriber line (DSL), cable and satellite). For purposes hereof, “consumers” are people who view, listen, or interact with the content (e.g., people watching television). Content suppliers often want to control the timing and manner of distribution of their content to a consumer. For example, a movie content supplier may release a movie for distribution only after a selected amount of time has elapsed since the movie's theater run, or a particular season in line with the content of the movie (e.g., distributing scary movies during the Halloween season, or Christmas movies during the Christmas season). The movie content supplier may further specify, for example, an amount charged per viewing, the mode of delivery to an end consumer, and a limited geographic region for release. In addition to placing these and other restrictions or limitations on the distribution of media assets, content suppliers usually require payment of royalties.

Many content suppliers and content users are not skilled in the art of digitizing and managing content for diverse digital service platforms (e.g., cable set-top box, digital subscriber line (DSL), and satellite platforms). Traditional brick and mortar establishments typically do not sell media content in digital form and have not dealt with issues such as encoding, encryption and license tracking. Moreover, in the digital space, the aggregation of compelling and diverse media content often requires licenses from numerous content suppliers who impose restrictions on the use of their media content. The ability to individually manage and distribute each media asset from each content supplier in accordance with their varying restrictions and requirements can also be a daunting task for many content users.

In view of the foregoing, there is a need for a system that manages and distributes media content from multiple content suppliers having unique requirements with respect to the storage, preparation, reporting, and distribution of their media assets while collecting information from consumers for use in determining the type of content to be distributed.

### SUMMARY OF THE INVENTION

In accordance with the invention, system architectures and methods are provided for delivering high quality media content to a consumer. Media content may include, for example only, literary works, static images, advertisements, audio programs, video, and other media assets. The system architectures are adapted to provide a consumer with high quality media content at a consumer location at any time desired by the consumer. For example, the selection of media content available to the consumer is greater than the selection possible with systems of the past. Additionally, targeted advertising opportunities are enhanced and made more precise through one or more components of the present invention.

The system architectures of the present invention preferably include a subscriber management system, a content management system, and a distribution system. The subscriber management system preferably creates and manages consumer accounts, as well as organizes consumers into groups for precision media targeting purposes. The content management system preferably creates, organizes and associates metadata (e.g., descriptive information regarding a particular asset) with media assets to create a media content offering (a collection of media content to be offered to consumers). The distribution system preferably includes a central server for interacting with consumers' browsers and for storing each media content offering created by the content management system and a rack for storing high bandwidth contents for streaming to consumers over a broadband or equivalent network.

The system architectures may also include an ad manager that provides the opportunity for precision-targeted ad campaigns based on factors such as, but not limited to, age, gender, geographic location, and previous viewing experiences, and a licensing server that preferably ensures that media content selections are only available to subscribers (e.g., consumers paying for a media content subscription service) who have purchased the media content and hold valid licenses.

In a preferred embodiment, the systems and methods of the present invention deliver high quality video on demand over an IP-based (Internet protocol) network by storing high bandwidth video content at or near a local network service provider (e.g., an Internet service provider). Periodically updated media content offerings provide access to useful metadata and assist the consumer in making video selections.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

FIG. 1 is a schematic of a system architecture in accordance with a preferred embodiment of the invention;

FIG. 2 is a schematic of a system architecture in accordance with another preferred embodiment of the invention;

FIG. 3 is a diagram of the subscriber management system of the system architecture of FIG. 1;

FIG. 4 is a schematic of a preferred embodiment of the account set-up;

FIG. 5 is a diagram of the subscriber management system of FIG. 3 showing the relation of different groups to one another;

FIG. 6 is a diagram of a preferred embodiment of the content management system of the system architecture of FIG. 1;

FIG. 7 is a diagram of a preferred method for creating a rollout;

FIG. 8 is a Venn diagram of a preferred step of the method for creating the rollout of FIG. 7;

FIG. 9 is a diagram of a preferred embodiment of the data warehouse of the system architecture of FIG. 1;

FIG. 10 is a diagram of a preferred embodiment of the central server of the system architecture of FIG. 1;

FIG. 11 is a diagram of a preferred embodiment of the rack of the system architecture of FIG. 1;

FIG. 12 is a diagram of a preferred embodiment of the ad manager of the system architecture of FIG. 1;

FIG. 13 is a diagram of a preferred embodiment of the licensing server of the system architecture of FIG. 1;

FIG. 14 is a schematic of a preferred architecture of localized components in relation to the central server of FIG. 1;

FIG. 15 is a schematic of a preferred method for the delivery of media content to a consumer;

FIG. 16 is a logic diagram of the method of FIG. 15; and

FIG. 17 is a logic diagram of a preferred ad procedure for use with the method of FIG. 16.

### DESCRIPTION OF THE PREFERRED EMBODIMENTS

Reference will now be made in detail to the present preferred embodiments (exemplary embodiments) of the invention, examples of which are illustrated in the accompanying drawings. Wherever possible, the same reference numbers will be used throughout the drawings to refer to the same or like parts.

The present invention is directed to a system architecture for a set of application program interfaces for delivering media content, for example only, literary works, static images, advertisements, audio programs and video to a consumer. More preferably, the present invention is directed to a system architecture for delivering video on demand (video that is viewable at any time selected by the consumer) to the consumer.

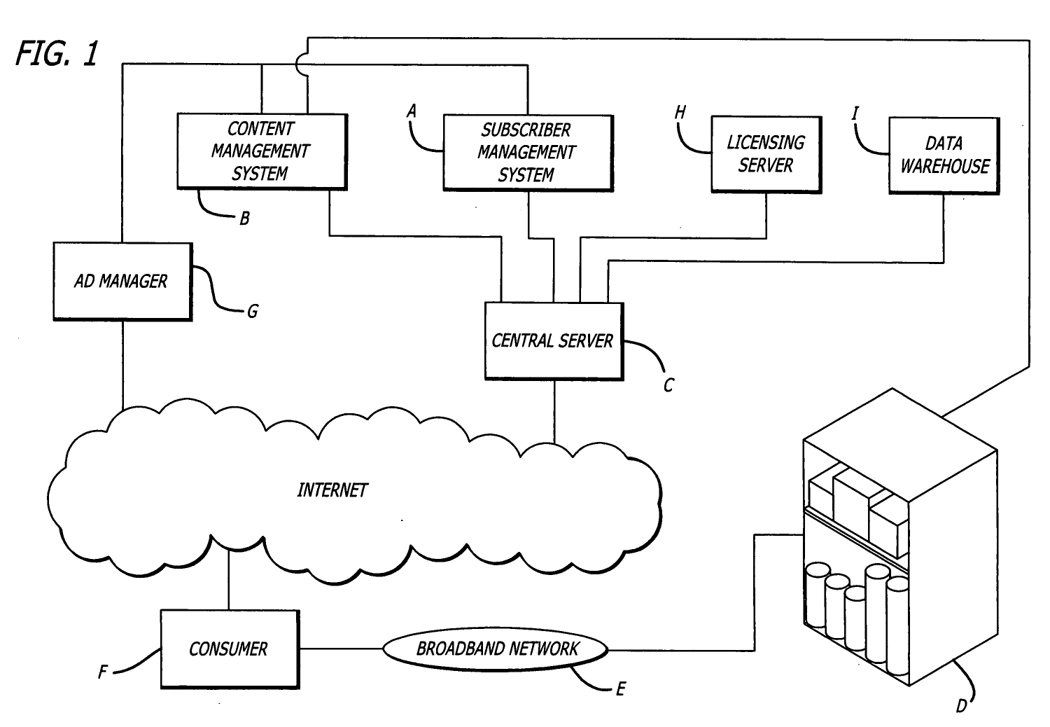

Referring to FIG. 1, the system of the present invention preferably includes at least four main components: subscriber management system A, content management system B, central server C, and rack D. Components A, B, C, and D, interact to deliver high quality media content to a consumer F through communications network E (e.g., a wire or wireless network such as DSL, cable, satellite, hard-wired phone technology and cell phone technology).

Subscriber management system A creates and manages a plurality of subscriber accounts. Content management system B preferably creates, organizes and associates metadata with media assets to create the media content offering that is delivered to and stored in a content database, preferably located at central server C. Content management system B also preferably creates and organizes ad campaigns that are then used by a remote data server for targeted consumer advertisement. Content management system B is also preferably used to push high bandwidth media content to regional or local locations, for example, at a rack D located in the vicinity of a network service provider. The push may be executed by electronic or manual delivery. By locating high-bandwidth media content locally, the media may be streamed more efficiently over a network service provider's broadband network for better quality delivery. In addition to containing content databases, central server C also preferably has a remote data server for interacting with consumers and a web server for delivering web content, including web pages and graphic files. Licensing server H checks that subscribers have purchased video content before providing digital licenses that are used to decrypt media content that is encrypted. Data warehouse I collects information about the usage of the service by subscribers for later reporting. Such information may include without limitation, demographic data, content usage data (e.g., viewing and/or listening patterns), and advertisement presentation tracking. The architecture of FIG. 1 provides an infrastructure that is simple to manage and scale, while maintaining the ability to provide high bandwidth media reliably to consumers on multiple service provider networks.

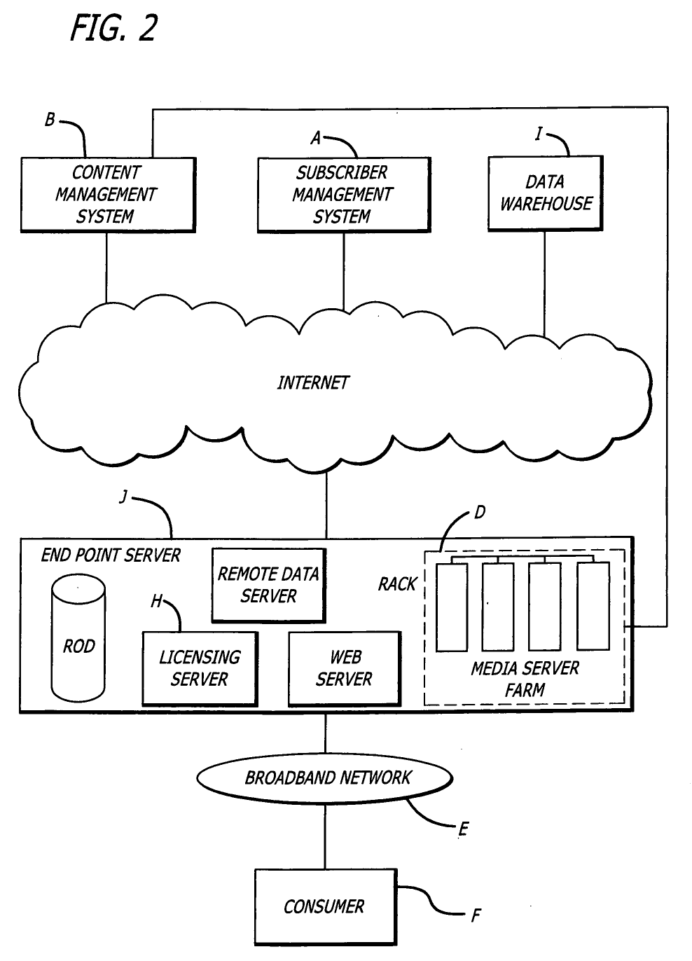

FIG. 2 shows another preferred embodiment of the system architecture of the present invention. The architecture of FIG. 2 is more de-centralized than that of FIG. 1. Instead of using a central server, the architecture of FIG. 2 localizes components to create more storage space at the central office location. For example, each local service provider may use an endpoint server J having a remote data server for accessing media content locally stored as a rollout (a media content offering that is available for exhibition to consumers during a designated interval of time) on a rollout database (ROD), and/or web server and a licensing server H.

It will be appreciated that high bandwidth content may be regionally or nationally located. Instead of locating high bandwidth content locally to utilize a local service provider's broadband network, the high bandwidth content may be placed near locations having broadband access to vast geographical areas. For example, one video server rack may be placed next to a regional broadband access point in California and another placed in Washington, D.C. to serve the entire U.S.

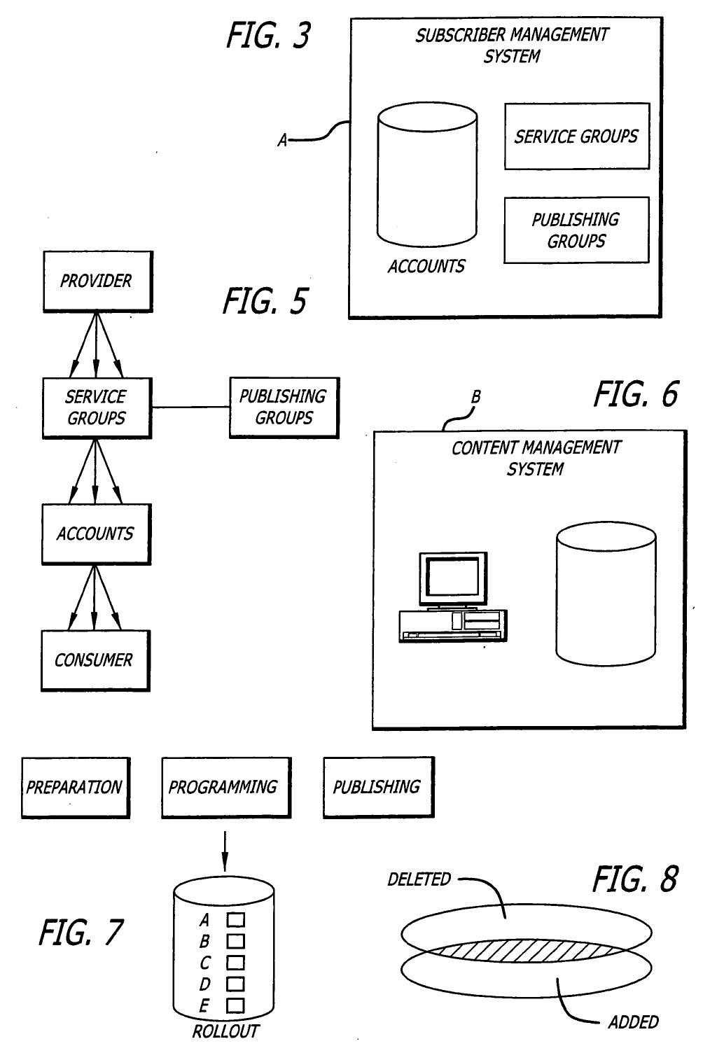

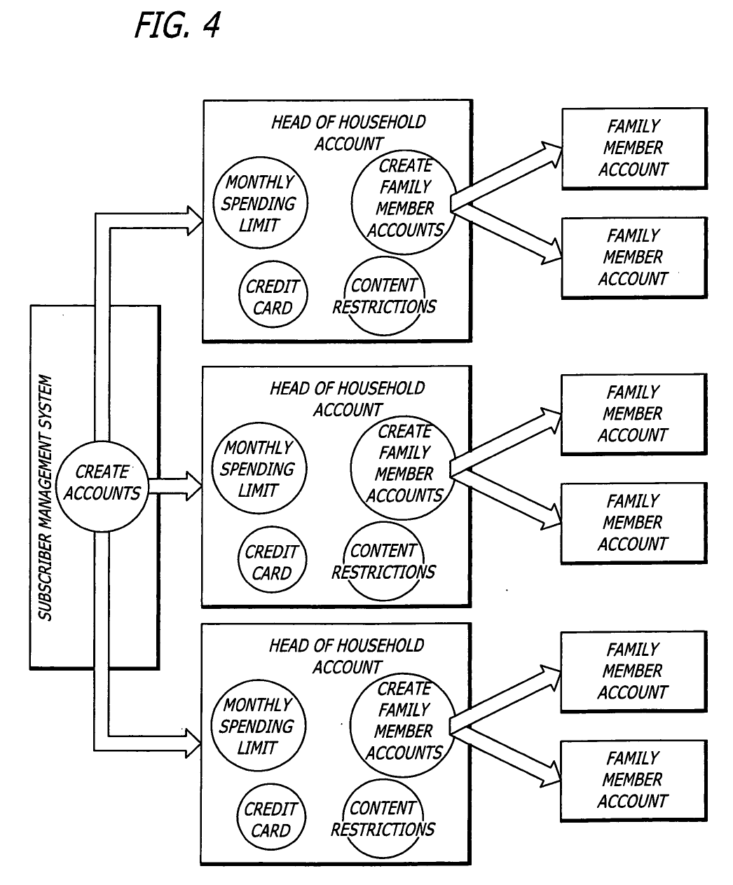

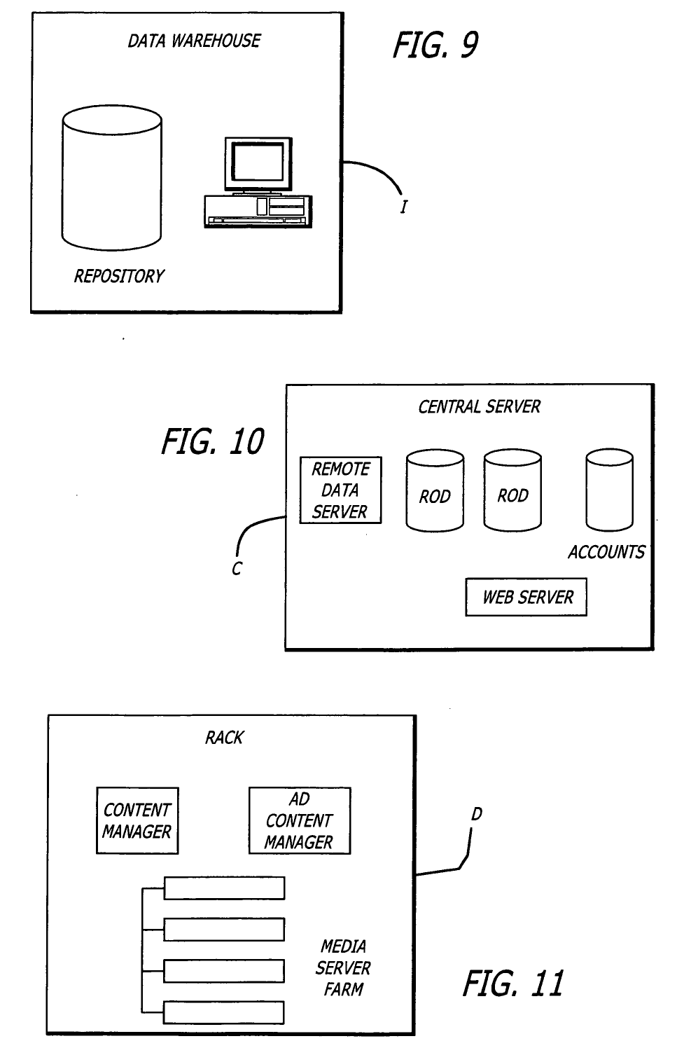

In reference to FIGS. 3 and 4, subscriber management system A preferably includes a processor and at least one medium for storing subscriber account information. The processor is preferably programmed to include an account set-up procedure. Two types of accounts are preferred: a head-of-household account (a main account) and one or more family member accounts (sub-accounts). The head-of-household account is the primary account holder who preferably controls all activity in the account, including any sub-accounts. Initially, an interested subscriber sets up a head-of-household account. In order to set up the account, the interested subscriber is asked to submit personal information such as (but not limited to) a user name, password, name, address, age, gender, and geographic location. Additionally, the head of household may also establish sub-accounts or family member accounts. A form of payment may also be established, for example, with credit card. A separate billing procedure may be used to bill sub-account holders. Preferably all of the information gathered from the head of household and any family members is stored in an accounts database containing the account information. The accounts database preferably tracks the total spending of the account, which includes the head of household and family member accounts. The accounts database may also be used to view account balances and limits, view an account-viewing history, issue return credit, and view financial transactions.

In setting up the account, the head of household may create a number of permissions for limiting the use of the account. Such permissions may include restrictions based on, for example, content type, Motion Picture Association of America (MPAA) ratings, spending thresholds, and age of the consumer. The permissions can be applied individually to the head-of-household and family member accounts. For example, a head of household may impose a monthly spending limit of $45 and restrict viewing of R-rated and adult movies on one family member account, while on a different family member account, imposing a higher spending limit and permitting R-rated material.

The processor of the subscriber management system is also preferably operable to maintain the subscriber accounts. One preferred method of maintaining an account includes a billing procedure that posts a bill if the total account amount due exceeds a predetermined value, or if an account timer has elapsed. The account timer measures the difference from the last occurrence that a bill was posted on the account and a new subscriber order. For example, if an account holder is paying by credit card, the billing procedure may post the account holder's debt to the credit card company if the account exceeds $30, or if the account has gone more than 30 days without purchasing or returning any video content. An example of a preferred subscriber management system is described in U.S. application Ser. No. 09/921,107, titled “Subscriber Management System,” filed Jul. 31, 2001, which claims priority to U.S. Application No. 60/280,664, the disclosures of which are hereby incorporated by reference herein.

Preferably, the subscriber management system is a software-based system that includes server software, a database (e.g., a relational database management system (RDBMS)), a computer, and client software, which preferably enables the subscriber management functions of the present invention. The computer may communicate with the server software and the database over a local or wide area network (e.g., the Internet) through a communications channel (e.g., HTTP). The communications channel may be wire or wireless (e.g., cable, satellite, DSL, and wireless land-based systems such as cell phone technology). The client software generates a graphical user interface to allow an operator (e.g., digital media service operator) to enter, modify, view or retrieve data stored in database and create subscriber accounts. The subscriber management system may operate as a stand-alone system or as part of a platform that offers multiple media-related services.

As shown in FIG. 5, the subscriber management system may also be used to group individual consumers into service groups (groups defined by provider and/or level of service) and publishing groups (a logical grouping of consumers that are related to a specific provider for the purpose of targeting media content). Placement of a consumer in a service group may depend on parameters related to the distribution of the media content offering and may include any one of or a combination of a service platform for distributing the media asset (e.g., wireless, DSL, the Internet, satellite, or cable), encryption, specific retailers for selling the media asset, a geographic location, a bit rate, and a method of delivery (e.g., streaming or digital downloads). The grouping of consumers into service groups facilitates targeting media content having contractual obligations or business rules associated therewith (e.g., geographic location, bit rate service, service provider, encryption, price, price range, method of delivery, and time frame available for offering the media content to consumers). “Business rules” define the parameters for using a particular media asset. For example, business rules for a first-run movie may require the content user to sell the movie at a set price (e.g., $3.95), or a particular price range, or to encrypt the movie, or to digitize the movie at a specific bit rate, or to deliver the movie via streaming or digital downloading over a cable network, rather than a DSL network. Each service provider, for example a network service provider, may cater to a plurality of service groups and publishing groups.

Different media content offerings can be targeted to different publishing groups concurrently, allowing for different sets of content to be available to each publishing group. For example, localized content, such as but not limited to news or sports features, can be presented to their local markets. Publishing groups may be used to group consumers into consumer groupings to perform further targeting such as localized, precision marketing. The targeted marketing may be directed to different geographically located consumers and/or, based on other consumer-related information such as any one of or a combination of demographics, content usage (e.g., the amount of time the media content was viewed or listened to, consumer viewing or listening habits, and consumer preferences for different types or genres of media content), and parental controls. For example, an elderly family member might receive different advertising than a pre-school family member, even though both consumers might reside at the same location. Additionally, a home across the river from another might receive different geographic advertising.

Media content offerings may be programmed for targeting by using the service group and publishing group information preferably stored in the accounts database. The targeting programming associated with a media content offering will control at least in part the accessibility of the media content offering to a particular consumer. Account-specific consumer-related information such as permissions or parental controls may be implemented when the consumer attempts to gain access to the media content offering through an account, or may be implemented in an account-specific media content offering.

FIGS. 6-8 illustrate one application of content management system B for providing a naming convention. Content management system B preferably provides a naming convention for media assets by associating media assets with metadata (e.g., descriptive information regarding a particular asset), prepares the media assets for delivery to particular groups of consumers (e.g., encoding media assets according to consumer bit rate requirements), and combines media assets to form a media content offering (e.g., combining a feature movie with a movie trailer, branding art, and advertisements). An example of a preferred content management system is described in U.S. application Ser. No. 09/921,100, titled “Content Management System,” filed Jul. 31, 2001, which claims priority to U.S. Application Ser. No. 60/280,691, the disclosures of which are hereby incorporated by reference herein.

Preferably, the content management system is a software-based system that includes server software, a database (e.g., a relational database management system (RDBMS)), a computer, and client software, which enables the content management functions of the present invention. Computer may communicate with server software and database over a local or wide area network (e.g., the Internet) through a communications channel (e.g., HTTP). The communications channel may be hard-wired or wireless (e.g., cable, satellite, DSL, and wireless land-based phone systems. The client software generates a graphical user interface to allow an operator to enter, modify, view or retrieve data stored in the database and create packages or rollouts for distribution to content users and consumers. The content management system may operate as a stand-alone system or as part of a platform that offers multiple media-related services.

In a preferred embodiment, content management system B selects media content for distribution to particular groups of consumers (e.g., publishing groups) based on, for example, geographical location, bit rate service, service provider, and contract terms, and aggregates the selected media content into a rollout. A rollout is a media content offering that is available for exhibition to consumers during a designated window of time. A rollout may include, for example, movie titles, directors, actors, CD title and track information, authors, retail information, and other facts or trivia associated with a particular media asset.

As shown in FIG. 7, the creation of each rollout preferably involves three component sub-processes. First, media assets are obtained and metadata is prepared for each media asset. Media assets are obtained from a media server farm (which stores a vast array of media assets for use by content management system B). In addition, the media assets are taken from their original form (for example, high quality video tapes) and encoded into digital files at a specific bit-rate (for example, 384 kbps or 750 kbps). The media assets may be encrypted after encoding to secure the content from unauthorized usage. The preparation of metadata involves data entry and quality control/quality assurance. Second, the media content offering is created and programmed into a rollout. This involves organizing media content and associating metadata with the media content. Third, the media content offering is verified through a quality assurance process. After the media content offering is programmed into a rollout, content management system B preferably locks the rollout configuration into its final form to prevent any further changes and to meet distribution deadlines, and transfers the rollout to a staging area for association with and distribution to a particular ROD.

After the rollout has been prepared, it is published (i.e., distributed for placement in a ROD). Identifying parameters used for each rollout may include provider identification, publishing group, rollout identification, and rollout identification of the rollout to be replaced. The same rollout may be placed in more than one ROD. Preferably, content management system B prepares a rollout tailored to the preferences of a geographical consumer population, thereby maximizing available storage space with material more likely to be viewed by the consumer population. Therefore, for example, consumers from Cincinnati would be directed to a different ROD than consumers from Vancouver. In addition, consumers in Cincinnati may in turn be directed to more than one ROD.

Content management system B publishes the rollout by using one or more identifying parameters and building or selecting a ROD, which is copied to and installed on central server C. As part of the rollout distribution process, content management system B may also be used to push high bandwidth (e.g., greater than 144 Kbps) media contents to regional or local locations, for example, a media server farm at rack D located in the vicinity of a network service provider. If a local provider lacks the ability to receive high bandwidth media assets electronically, then the high bandwidth media assets may be pushed to the provider using other known delivery methods such as manual delivery and satellite transmission. Rack D is preferably located on a network service provider's local network and accessible through communications network E. Additionally, supporting data such as HTML and/or graphic image files (e.g., artwork) that may be associated with the media content offering are preferably distributed to the web server located at central Server C. After distribution, consumers may be directed to the rollout for a selected interval of time while another rollout is prepared for a subsequent viewing period. Content management system B may also create and organize ad campaigns that are then used by ad manager G for targeted consumer advertisements.

An example of a content distribution system operable with the present invention is described in U.S. Application Serial No. (to be assigned), titled “Content Distribution System,” filed Jul. 31, 2001, which claims priority to U.S. Application Ser. No. 60/280,626, the disclosures of which are hereby incorporated by reference herein.

As shown in FIG. 8, each rollout is preferably updated on a regular basis, preferably weekly. The updating of a rollout preferably includes a rollout addition list, a rollout deletion list, and a rollout total list. The rollout addition and deletion lists include preferably only the names of those media asset files that must be added to or deleted from the previous rollout to match the rollout total list for the new rollout. Each newly created rollout is meant to supplant the previous rollout. For example, if consumers are directed to a rollout for the week dated December 5, the programmers may deliver the new rollout dated December 12 while the consumers are still being directed to the December 5 rollout. After a selected interval of time, consumers will be directed to the December 12 rollout while the next rollout is being prepared. Each rollout usually differs in content by only 5 to 10 percent over the previous rollout, however any percentage of content may be replaced. It is preferred that higher bandwidth media contents be pushed separately into a content storage device located at or near a network service provider, such as rack D shown in FIG. 1. Lower bandwidth media may be delivered with the rollout, or may be delivered to the web server via File Transfer Protocol (FTP). Rollouts are typically delivered to central server C as shown in FIGS. 1 and 10.

As shown in FIG. 10, central server C preferably includes at least one ROD, an accounts database, and a remote data server. As mentioned previously, each ROD includes a rollout prepared by the content management system. Central server C also preferably includes a remote data server that acts as a gateway for a consumer wishing to access the media content. The remote data server preferably includes access to an ad timer that is used to time intervals between advertisement deliveries. The ad timer functions, for example, by time-stamping a consumer session profile maintained by the remote data server. Central server C also preferably uses an accounts database. This accounts database may also be the same as the one used by the subscriber management system. Central server C also preferably includes a web server that stores the assets of lower bandwidth, for example, JPEG or GIF coded content.

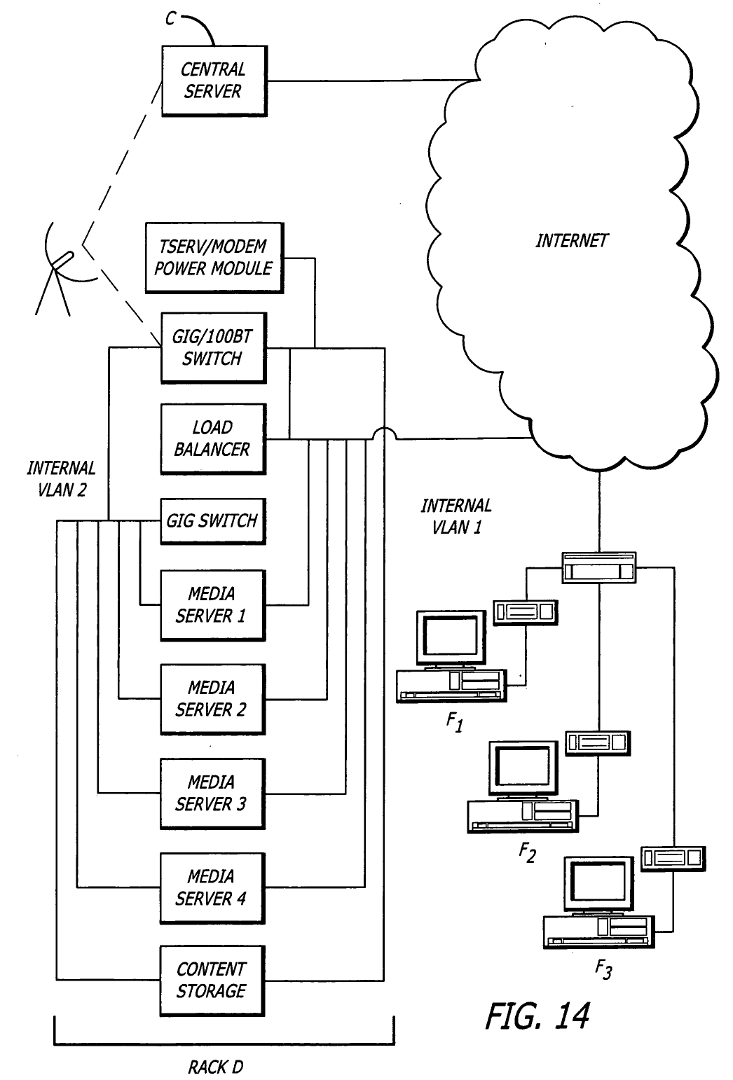

With reference to FIGS. 11 and 14, rack D includes a file repository for storing encrypted and unencrypted media content, preferably high bandwidth streaming media content, and at least one media server, preferably a plurality of media servers situated in a media server farm. Rack D also preferably includes ad content storage for storing high bandwidth streaming ad content. It is to be understood that both the consumer requested content storage and ad content storage may be combined into one larger content storage device. Also, media servers may be arranged in any manner suitable for the distribution of any suitable combination of video content and ad content. Rack D is preferably located at or near a network service provider in order to take advantage of a provider's broadband network. In use, stream requests from consumers are load-balanced among multiple available media servers. In addition to load-balancing, having multiple media servers allows for a fail-over in the event of hardware or other failure. Additional servers may be added as necessary. Content is preferably made available to the media servers through a private Gigabit Ethernet (GigaE) Virtual Local Area Network (VLAN). The load balancer provides the GigaE interface to the broadband network and also provides load balancing between the media servers. The load balancer keeps track of all the simultaneous streams on each media server and will forward the next streaming request to the least used server. The GigaE switch provides the backbone for the private Gigabit VLAN, which enables secure and fast communication between the media servers and content storage. Content storage is preferably provided by a network-attached file server with one or more GigaE interfaces which connect to the GigaE switch. This device enables file sharing among all media servers, so they can all access the same content.

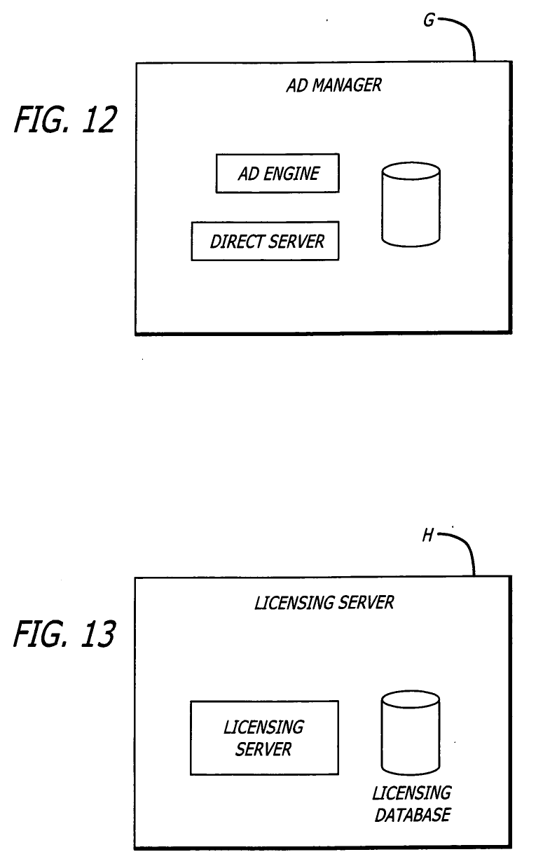

As shown in FIG. 12, ad manager G (for use in the architecture illustrated in FIG. 1) contains metadata for ads and their file names. The content management system is also preferably responsible for preparing ad campaigns which are delivered to an ad engine in a similar way that metadata is delivered in a rollout to the ROD. However, the ROD and the ad engine are preferably independent entities. This independence allows publishing groups to get the same ROD, but different ad campaigns. An ad campaign can be aimed, for example, at a particular gender, age, or regional affiliation, or any combination thereof.

As shown in FIG. 13, licensing server H is responsible for handling licensing requests and issuing license keys to consumers requesting a particular piece of media content. Licensing server H communicates with the remote data server to check in the accounts database to ensure that the subscriber has purchased and owns a valid license before issuing a key to the subscriber. The license issued may be adapted to expire after a selected interval of time.

As subscribers interact with the service, information relating to such interaction is stored in the accounts database and in a number of log files located on central server C. The information stored in the accounts database includes, but is not limited to, media content purchases and consumer account detail changes. The information stored in the log files includes, but is not limited to, media content views and consumer navigations. On a regular schedule, preferably daily, programs residing on data warehouse I extract updated database records from the accounts database and updated records in the log files, both preferably located on central server C. These programs load the updated database records into data warehouse I to be used for reporting purposes. These reports include, but are not limited to, subscriber accounts, subscriber demographic breakdowns, media content purchases, media content reviews, and the habits of the subscribers associated with the use of media content (e.g., viewing and/or listening habits). These reports are used for modifying the content makeup that is programmed into the service to provide subscribers with a more satisfying experience. They are also used to calculate royalty payments required by the owners of the media content within the service.

FIG. 14 shows a schematic of a preferred embodiment of the interaction between central server C and the local network. Central server C is preferably positioned to interact with both consumer PCs F₁, F₂, F₃ and rack D. Central server C may communicate with either of these entities via the Internet, wireless, DSL, satellite, or cable connections. As shown in rack D and explained above, media servers 1-4 are connected to a load balancer which helps distribute content deliveries to the consumers in a more efficient manner. Terminal servers/modem hardware is preferably installed in rack D to provide backup remote and console access.

Administrative access to the rack is preferably only allowed through the virtual private network (VPN). The VPN device is used to establish a secure communication channel between the rack and a system central office. The media servers are preferably built with two network interfaces which allow them to communicate on both the broadband network and the private VLAN. For security reasons, all the interfaces connecting to the broadband network are preferably only configured with access to the services used for streaming and web serving.

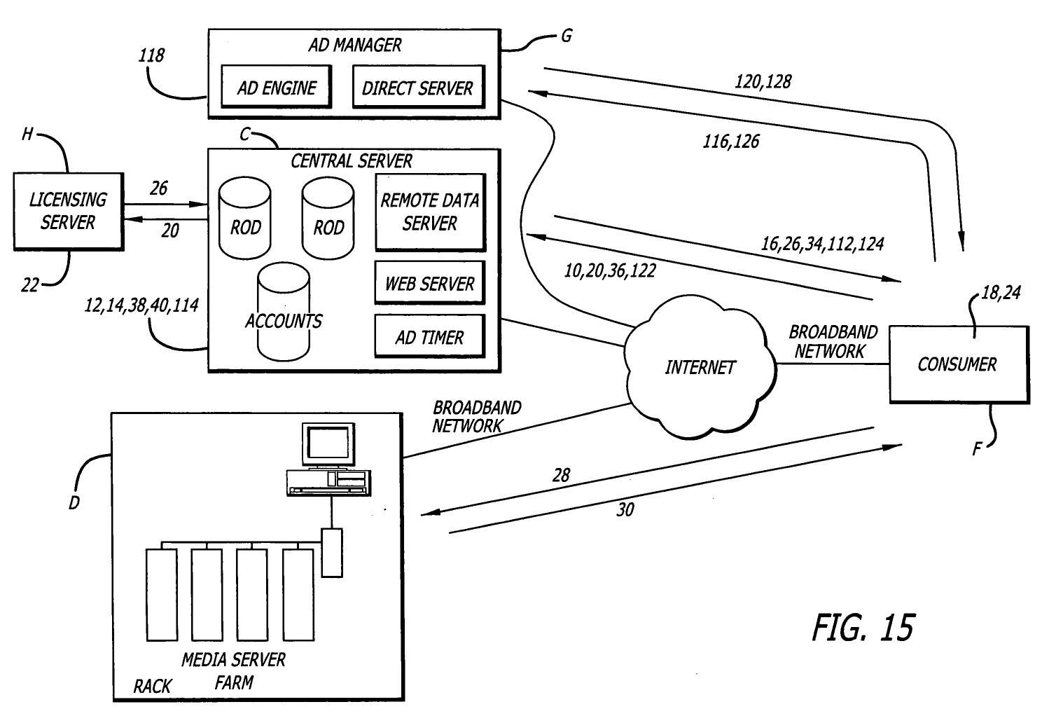

As shown in FIGS. 15, 16, and 17, a preferred method of media content distribution to consumers is illustrated. In step 10, a consumer with web browser access makes a selection request after accessing a provider website. It should be understood that the selection request may also be made through the central server as well. A remote data server or application server located in central server C consults an accounts database to see if the consumer has an account in step 12. If the consumer does not have an account, an account set-up procedure may be initiated in step 210 or the consumer is denied access. The account may be set-up automatically or manually over the phone using known methods. Following the account set-up procedure, the consumer is then permitted to continue. If the consumer has an account, then the remote data server checks the permissions associated with the consumer's account in step 14. These permissions can be, for example, restrictions on a particular genre of content or spending amounts associated with a family member of a head-of-household account. Though preferred, the present invention need not include an accounting procedure. Following step 14, an ad procedure 110 is initiated (described below).

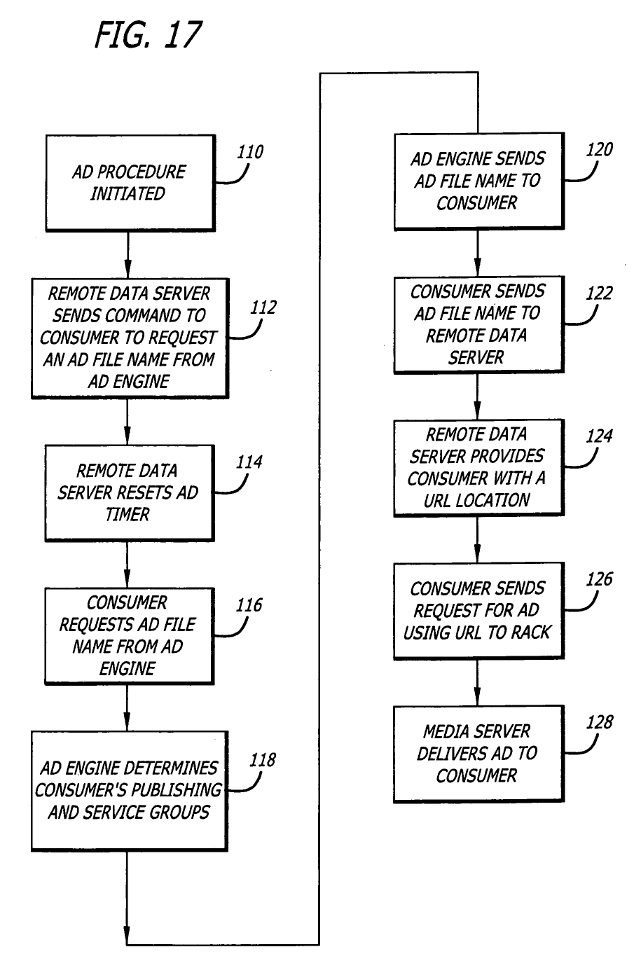

As shown in FIG. 17, ad procedure 110 is commenced when the consumer or the consumer's visual display (e.g., computer, television set, or other audio-visual device) requests an ad file from an ad engine in step 112. The ad engine preferably includes a database of file names of ads to be targeted to specific publishing groups of consumers. In step 114, the remote data server resets an ad timer. The ad timer preferably times consumer interaction rather than a particular content. In step 116, the consumer's visual display requests the ad file name from the ad engine. In step 118, the ad engine determines the consumers publishing group and service group (e.g., bit rate service requirement) by accessing a database shared by the subscriber management system. In step 120, the ad engine sends the ad file name to the consumer's visual display. Thereafter, the consumer's visual display sends the request for an ad using a universal resource locator (URL) to rack D in step 126. The media server in step 128 delivers the ad to the consumer, thus completing an ad procedure. During the ad procedure, it is understood that one or more steps may be interchanged with others. For example, step 114, resetting the ad timer, may be accomplished anywhere during the ad procedure. Additionally, this ad procedure is preferred for streaming media advertisements. It is understood of course, that advertisements of lower bandwidth may be stored on central server C, for example in the web server. In such an instance, the procedure may be confined totally to central server C, or if the high bandwidth advertisement media and low bandwidth advertisement media are both to be used, the procedure may be readily adaptable to include interaction between both the web server and rack D (see FIG. 1). Another example of a preferred ad procedure may be found in U.S. application Ser. No. 09/825,758, titled “Internet Protocol-Based Interstitial Advertising,” the disclosure of which is hereby incorporated by reference. Though preferred, the ad procedure may be omitted and not affect the distribution of content to the consumer.

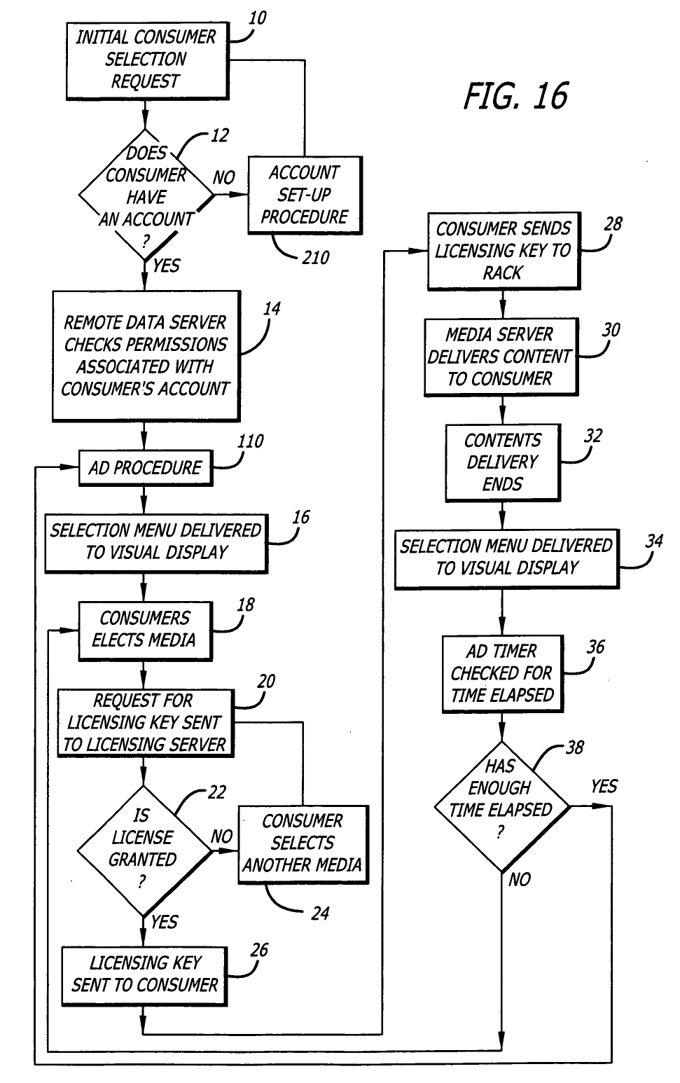

As shown in FIG. 16, after completion of ad procedure 110, the remote data server delivers a selection menu to the consumer's visual display in step 16. In step 18, the consumer selects the media content they want to see. In step 20, the consumer's visual display transmits a request for a licensing key for a decryption program to the licensing server. The licensing server is responsible for handling licensing requests and issuing license keys for decryption programs to end consumers requesting a particular media content. Preferably, decryption programs are served by an independent third party. In step 22, the licensing server either grants a license or denies a license. In making the determination of whether to grant or deny a license, the licensing server preferably accesses an accounts database having information associated with the consumer making the request for the selected media content. If the licensing server denies a license, then in step 24 the consumer selects another media content to view and repeats step 20. Once a license is granted, in step 26 a licensing key and decryption program is sent to the consumer's visual display. The consumer's visual display in step 28 sends the licensing key and decryption program to the rack D. The media server in step 30 decrypts and delivers the media content to the consumer.

Once content delivery ends in step 32, the data server generates a selection menu using data retrieved from the rollout in step 34. In step 36, the ad timer is checked for time elapsed. At this point, the remote data server determines if enough time has elapsed in step 38. If the time interval for initiating another ad procedure 110 has not elapsed, then the consumer proceeds to make a selection as in step 18 from a selection menu in step 16, thus repeating steps 18 through 32. However, if enough time has elapsed since the last ad procedure 110, then ad procedure 110 is again initiated. After completion of the second ad procedure 110, steps 16 through 38 are repeated.

As will be appreciated by those skilled in the art, various of the above steps may be interchanged or omitted. For example, if no ad procedure is used, steps 110, 36, and 38 may be omitted. Additionally, instead of sending a licensing key to the consumer in step 26, the key may be sent directly to the rack to begin content delivery to the consumer, thereby omitting steps 26 and 28.

In another embodiment of the present invention, instead of replacing a rollout with a subsequent rollout to provide consumers with a fresh media content offering, a publishing group database (“PGD”) may be used. The PGD may be refreshed without time or quantity restrictions (i.e., one or more media content offerings may be added to the PGD, deleted from the PGD, replaced, edited, or otherwise modified in the PGD at any time by the system or the system operator to change the composition of all the media content offerings stored on the PGD).

Once delivered to a destination (e.g., central server C or rack D), the media content offering preferably forms a part of the PGD and functions until such time a command is received to add, delete, replace, edit, or otherwise modify the media content offering. Media content offerings may be programmed with begin dates and end dates so that the media content associated with a particular media content offering preferably will be offered to consumers for only a selected interval of time.

Media content stored on the PGD may be refreshed based on, for example only, any one of or a combination of consumer-related information such as geographical location, demographics, content usage (e.g., the amount of time the media content was viewed or listened to and consumer viewing or listening habits), and parental controls; and/or contractual obligations associated with the media content (e.g., bit rate service, service provider, encryption, price, price range, time frame available for offering the media content to consumers).

A preferred method of content distribution to consumers utilizing a PGD may be performed using the method illustrated in FIGS. 15, 16, and 17, except that a selection menu may be generated using data retrieved from the PGD instead of a rollout.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for developing media content and offering the media content to a plurality of consumers, the system comprising:
a content management system having a processor and a graphical user interface including input fields adapted for permitting an operator to combine media assets and metadata based on selected groupings of the consumers to create at least one media content offering, said content management system adapted for permitting the operator to select the at least one media content offering for distribution to the selected groupings of the consumers based on at least one of a geographical location, a bit rate service, a service provider, and a contractual term, said content management system adapted for permitting the operator to aggregate selected media content offerings into at least a first rollout offered to at least a first of the selected groupings of the consumers and at least a second rollout offered to at least a second of the selected groupings of the consumers, the first of the selected groupings of the consumers being different from the second of the selected groupings of the consumers, the first rollout being targeted to the consumers in the first of the selected groupings, and the second rollout being targeted to the consumers in the second of the selected groupings;
a content database for storing at least a portion of the at least one rollout delivered from said content management system;
a subscriber management system for creating a plurality of subscriber accounts, said subscriber management system including at least one processor, a graphical user interface including input fields, and at least one medium for storing subscriber account information, said processor and said graphical user interface of said subscriber management system adapted for permitting the operator to maintain the subscriber accounts and including a procedure for billing the subscriber accounts, said subscriber management system adapted for permitting the operator to group individual consumers into at least the first and the second of the selected groupings based on at least one of a geographical location, a bit rate service, a service provider, and a contractual term, the first and the second of the selected groupings of the consumers receiving the first and the second rollouts, respectively;
a rack for receiving the selected media content offerings from said content management system, said rack including a file repository for storing the media content associated with the selected media content offerings; and
a server for distributing the media content stored in said file repository.

2. The system of claim 1, wherein said processor of said subscriber management system manages consumer-related information, further comprising a database storing the consumer-related information.

3. The system of claim 2, wherein the consumer-related information includes billing information.

4. The system of claim 2, wherein the consumer-related information includes demographical information.

5. The system of claim 1, wherein said processor of said subscriber management system collects information associated with the use of media content selected from the media content offering by each consumer.

6. The system of claim 5, wherein the content use information includes consumer media content preferences.

7. The system of claim 5, wherein the content use information includes an amount of time each consumer uses the selected media content.

8. The system of claim 1, wherein the media content offering is programmed to expire after a fixed interval of time.

9. The system of claim 1, wherein said content database stores a plurality of media content offerings to form a composite media content offering.

10. The system of claim 9, wherein said content database is refreshed to change the composition of the composite media content offering.

11. The system of claim 1, wherein said server is a web server, further comprising a video file repository for storing video associated with the media content offering and a video server.

12. The system of claim 1, further comprising a licensing server grants a license to each consumer requesting use of selected media content requiring the license upon a determination that the consumer is permitted to use selected media content.

13. The system of claim 12, wherein the license includes a decryption key program decrypting media content that is encrypted.

14. The system of claim 1, further comprising an ad manager for targeting advertisements to the consumers.

15. The system of claim 2, wherein the consumer-related information includes content usage by members of each selected group of consumers.

16. The system of claim 15, wherein the content usage includes viewing habits by members of each selected group of consumers.

17. A system for developing media content and offering the media content to a plurality of consumers, the system comprising:
a content management system having a processor and a graphical user interface including input fields adapted for permitting an operator to combine media assets and metadata based on at least one common business rule associated with one or more of the media assets to create at least one media content offering for selected groupings of the consumers, the business rule prescribing how one or more of the media assets may be used, said content management system adapted for permitting the operator to select the media content offering for distribution to the selected groupings of the consumers, said content management system adapted for permitting the operator to aggregate selected media content offerings into at least a first rollout offered to at least a first of the selected groupings of the consumers and at least a second rollout offered to at least a second of the selected groupings of the consumers, the first of the selected groupings of the consumers being different from the second of the selected groupings of the consumers, the first rollout being targeted to the consumers in the first of the selected groupings, and the second rollout being targeted to the consumers in the second of the selected groupings;
a content database for storing at least a portion of the first rollout and at least a portion of the second rollout delivered from said content management system;
a subscriber management system for creating a plurality of subscriber accounts, said subscriber management system including at least one processor, a graphical user interface including input fields, and at least one medium for storing subscriber account information, said processor and said user graphical interface of said subscriber management system adapted for permitting the operator to maintain the subscriber accounts and including a procedure for billing the subscriber accounts, said subscriber management system adapted for permitting the operator to group individual consumers into at least the first and the second of the selected groupings based on at least one of a geographical location, a bit rate service, a service provider, and a contractual term, the first and the second of the selected groupings of the consumers receiving the first and the second rollouts, respectively;
a rack for receiving the media content offering from said content management system, said rack including a file repository for storing the media content associated with the media content offering; and
a server for distributing the media content stored in said file repository.

18. The system of claim 17, wherein said content database storing a plurality of media content offerings to form a composite media content offering.

19. The system of claim 17, wherein said server is a web server, further comprising a video file repository for storing video associated with the media content offering and a video server.

20. The system of claim 17, further comprising a licensing server granting a license to each consumer requesting use of selected media content requiring the license upon a determination that the consumer is permitted to use selected media content.
